(19) United States
(12) Patent Application Publication
(10) Pub. No.: US 2017/0214982 A1
(43) Pub. Date: Jul. 27, 2017

(54) SYSTEMS AND METHODS FOR MERGING MULTIPLE ANGLE VIDEO FEEDS

(71) Applicants: Shane Breckenridge Cowherd, Colorado Springs, CO (US); Chad Jeremy Cargill, Harrah, OK (US); Tommie Carroll Gipson, Eaton, CO (US); Austin Laramore, Carbon, TX (US)

(72) Inventors: Shane Breckenridge Cowherd, Colorado Springs, CO (US); Chad Jeremy Cargill, Harrah, OK (US); Tommie Carroll Gipson, Eaton, CO (US); Austin Laramore, Carbon, TX (US)

(21) Appl. No.: 15/135,889

(22) Filed: Apr. 22, 2016

Related U.S. Application Data
(60) Provisional application No. 62/281,445, filed on Jan. 21, 2016.

(51) Int. Cl. H04N 21/8549; H04N 5/232; H04N 5/77; H04N 5/91

(52) U.S. Cl. CPC H04N 21/8549; H04N 5/91; H04N 5/23203; H04N 5/77

(57) ABSTRACT

An on-demand replay (“ODR”) system comprises a plurality of devices configured for automatically merging multi-angle video clips of an event. The devices can be configured to remotely start and stop recording of an event by a plurality of connected video cameras. Merged video clips may be transferred to a portable computing device.

### CROSS-REFERENCE TO RELATED APPLICATIONS

This application claims the benefit of priority from U.S. Provisional Application No. 62/281,445, filed on Jan. 21, 2016, the disclosure of which is hereby incorporated by reference in its entirety.

### FIELD OF THE INVENTION

The present invention relates to systems and methods for merging video clips taken from a plurality of different angles. In particular, the present invention relates to merging video feeds taken from multiple angles at a sporting or entertainment event.

### BACKGROUND

Video replays are an important coaching tool. Current replay systems use High-Definition Multimedia Interface (HDMI) cameras used by sport teams to film their games as the source for their video feed. These systems have to provide a means of getting the HDMI feed into the replay system network. This is done by using an HDMI cable plugged into the HDMI OUT port of the video camera and plugging the other end of the HDMI cable into the HDMI IN port of a game capture card. The video out port of the game capture card is then connected to the USB port of a computer. The game capture card converts the HDMI video into a usable video format which can be used by computer software. Then the replay software on the computer processes the video clip and sends the clip to all the computing devices connected to the network. However, the computers can cause various problems interfering with this process. Common problems include firewalls preventing transmission, slow processors, aging computers, and laptop battery life issues.

In order to obtain comprehensive analytical data, teams can film games from multiple angles. In football, for example, often there is a camera placed high above the field in a filming box and another camera mounted to a pole in the end zone. By using two replay systems, teams can get the clips from multiple angles to come in to the computing devices simultaneously. This, however, requires multiple (two or more) computers, multiple game capture cards, etc. Users also have to spend time getting all the settings straight on both computers to get them both transmitting through a same network. This is time intensive and causes many problems for users. Therefore, there is a need to avoid the use of multiple computers, and minimize user setup time in order to merge video clips from multiple angles.

Currently, users have to go through many steps to get computers placed at different angles to communicate with each other to get video clips to synchronize together. This is a cumbersome process and the user is required to go through many steps in order to view an event from different camera angles.

### SUMMARY

According to an embodiment, an on-demand replay system comprises: (A) a plurality of video cameras for recording one or more video clips of an event from multiple angles; (B) a plurality of devices in cooperative communication, wherein at least one video camera is connected to each device, and wherein each device is configured to constantly monitor and recognize each of the other devices; and (C) one or more portable computing devices for receiving the multiple angle video clips. Each device comprises: a compact case, wherein the case comprises a front panel; a heat sink located above the case; a recording button mounted on the front panel of the case; and a High-Definition Multimedia Interface (HDMI) input port mounted on the front panel of the case, wherein the video camera is connected to the device through the HDMI input. The device further comprises a HDMI capture card for capturing the one or more recorded video clips from the connected video camera. A first and a second video camera may be positioned such that the first video camera records a first video clip of the event from a first angle and the second video camera records a second video clip of the event from a second angle. Each portable computing device is configured to allow a user to view the first video clip from the first angle, the second video clip from the second angle and a merged first and second video clip from the first and second angles. The video clip comprises a sporting or entertainment event or a sporting practice session.

The device further comprises: one or more computer readable storage media; program instructions stored on at least one of the one or more computer readable storage media for execution by at least one of the one or more computer processors. The program instructions comprise: program instructions to receive a signal from the other devices to commence or to terminate the recording of the video clip; program instructions to broadcast its name and recording status to the other devices; and program instructions to check a current recording status of the other devices. The portable computing device further comprises program instructions for constantly polling the plurality of devices to determine if a new a video clip has been added.

According to another embodiment, a method for managing multiple angle video clips comprises: providing a plurality of video cameras for recording one or more video clips of an event from multiple angles; providing a plurality of devices in cooperative communication, wherein each device is connected to at least one of the video cameras, and wherein each device constantly checks the recording status of all the other devices; and designating a first device as a primary device upon the condition that the first device detects a signal to start or stop the recording before all the other devices. The method further involves enabling each of the devices to broadcast its name and recording status to all the other devices. Upon detecting the signal, the primary device instructs all the other devices to commence recording if it determines that none of the other devices are recording the event. Alternately, the primary device instructs all the other devices to stop recording if it determines that one or more of the other devices are recording the event. Upon stopping the recording, each of the devices is configured to access and store the recorded video clips. The recorded video clips may be transferred to the primary device, wherein the primary device is configured to format, edit and merge the video clips. The method further involves transferring the merged video clips to a portable computing device.

According to another embodiment, a method for remotely recording a video in an equine arena comprising a chute is disclosed. The method comprises: deploying a first device at a back of the arena, wherein the device comprises a recording button, and wherein the device is connected to a video camera; loading livestock inside the chute; providing a signal to remotely actuate the recording button, wherein the actuation of the recording button commences a video recording session; remotely opening a front gate of the chute to coincide with commencement of a practice run; and providing a signal to remotely stop the video recording session when the practice run is concluded. The method further comprises transferring the recorded video to a portable computing device where it can be edited, formatted and replayed as needed.

### BRIEF DESCRIPTION OF THE DRAWINGS

The accompanying figures further illustrate the present invention. The components in the drawings are not necessarily drawn to scale, emphasis instead being placed upon clearly illustrating the principles of the present invention.

FIG. 1 illustrates an on demand replay system according to an embodiment.

FIG. 2A-2E illustrate a back, front, top, bottom and perspective views of an exemplary device for coordinating the merging of video clips from multiple camera angles according to an embodiment.

FIG. 3 is a block diagram of a device according to an embodiment.

FIG. 4 is a flowchart illustrating management of a multi-angle video stream according to an embodiment.

FIG. 5 is a flowchart illustrating the capture of a video signal according to an embodiment.

FIG. 6 is a flowchart illustrating management of a video stream at an at an entertainment or sporting event arena.

FIG. 7 is a flowchart illustrating management of a video stream at rodeo arena or practice area.

FIG. 8A is a block diagram of a rodeo arena according to an embodiment.

FIG. 8B is a block diagram of a practice area.

### DETAILED DESCRIPTION

Methods, systems and devices for merging multiple angle video clips into a single video feed are disclosed herein. The terms “video clip”, “video stream”, “video” and “video files” are used interchangeably herein. A video can include any video or audio file. For example, the media file may be an uncompressed video file. The video clip can be a reproduction of an event that can be replayed. Video clips may be short clips of video files that are usually part of a longer recording. The source of the video may be a High-Definition Multimedia Interface (HDMI)-compliant source device, such as a display controller or HD video-capable cameras.

As used herein, the term “event” includes any activity that requires or can benefit from the use of instant playback ability for analysis. The event may be a sporting or other entertainment event. For example, the event may be a game of football, soccer, baseball, basketball, etc. or a practice session thereof. The event may be an action event and/or any other event in time. As used herein, the term “portable computing device” means a smartphone, a laptop, a tablet computer or any suitable mobile computer.

Exemplary embodiments now will be described more fully herein with reference to the accompanying drawings. This disclosure may, however, be embodied in many different forms and should not be construed as limited to the exemplary embodiments set forth herein. Rather, these exemplary embodiments are provided so that this disclosure will be thorough and complete, and will fully convey the scope of this disclosure to those skilled in the art. In the description, details of well-known features and techniques may be omitted to avoid unnecessarily obscuring the presented embodiments.

A. On-Demand Replay System

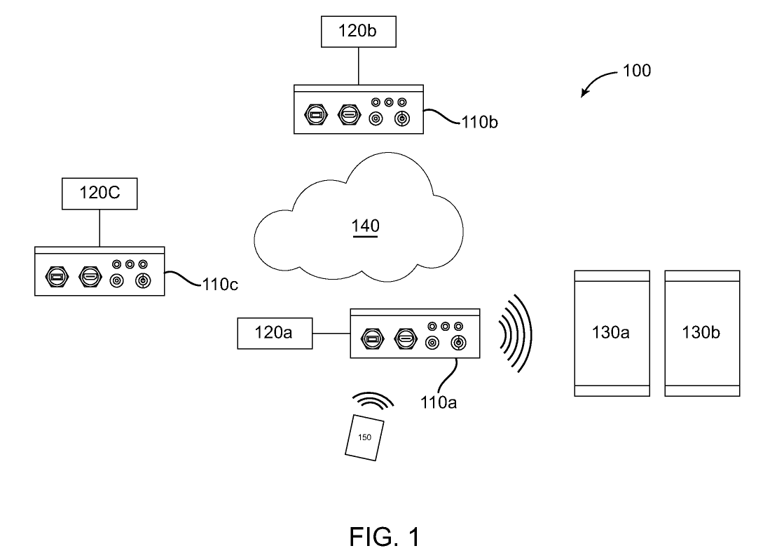

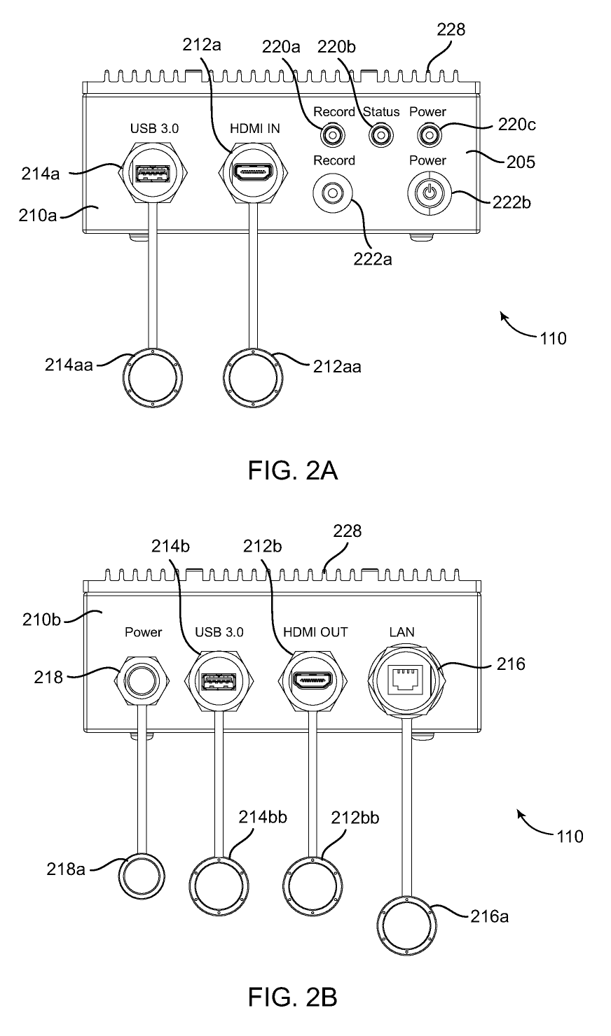

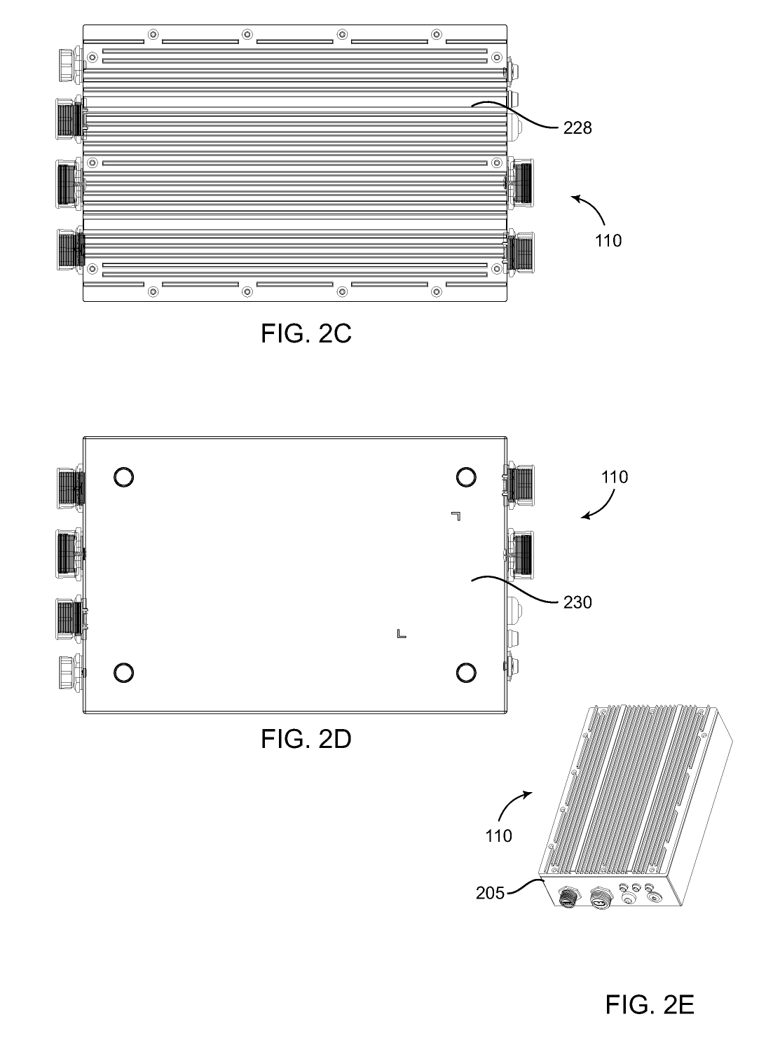

Referring to FIG. 1, an on-demand replay (“ODR”) system 100 comprises a plurality of devices 110a, 110b, 110c (collectively “devices 110”). The devices 110 are configured for automatically merging multi-angle video streams of an event. The devices 110 can be configured to remotely start and stop recording of an event by a plurality of connected video cameras 120a, 120b, 120c (collectively “video cameras 120”) with an optional electronic control unit, such as, a remote controller 150. The devices 110 are described further with reference to FIGS. 2A-2E below.

The video stream may include a plurality of views/perspectives of an event. To ensure sufficiency of analytical data, each of the devices 110 and connected video cameras 120 may be positioned at different locations in a facility (for example, at one or more corners around a perimeter and in a booth of a sport stadium). The connected video cameras 120 may be oriented at different angles such that multiple angled video streams of the same event (for example, a particular play) can be obtained during a recording session.

The devices 110 can be configured to process, store and transmit the video stream to one or more portable computing devices 130a, 130b (collectively “computing devices 130”). The devices 110 can operate using portable batteries (not shown). Therefore, the devices 110 can be used not only where Internet connection is not available but also where power is not available. The ODR system 100 can also include one or more routers, a high-powered antenna (where applicable), cables, and other standard components necessary for the devices 110 to communicate with the video cameras 120 and the portable computing devices 130.

The devices 110 are in a mesh or peer-to-peer network 140. Each of the devices 110 can be configured to automatically look for and recognize other connected devices in the network 140. The network 140 may be any type of network including a local area network (LAN) or wide area network (WAN) implemented as a wired or wireless network. In many embodiments, the network interface 140 may be a wired Ethernet connection. Advantageously, however, the ODR system 100 does not require Internet connectivity to transfer and merge the multiple camera angle video stream from the video cameras 130 to the portable computing devices 130.

One of the devices 110, for example, 110a, functions as a “primary device”. A “primary device”, for the purposes of this disclosure, is the device that first or initially receives/transmits a signal to initiate or stop recording of the video stream. The primary device 110a can be configured to automatically look for, recognize, and synchronize the recording and merging of video streams with secondary devices 110b, 110c. However, it is to be understood that device 110a is not a dedicated primary device but merely a device that receives/transmits the signal to initiate or stop recording for a particular recording session. In other recording sessions, a primary device may become a secondary device, and one of the secondary devices may become the primary device, depending upon which device receives/transmits the signal to initiate or stop recording.

The merged video stream may be transmitted from the primary device 110a to one or more portable computing devices 130. A user can access multiple angle views of the desired event from one or all of the portable computing devices 130. The one or more embodiments of the ODR system 100 may be used to provide users access to instantaneous or on-demand replay of a particular recording session.

B. Exemplary Device for Merging Multi-Angle Video Clips

An embodiment of device 110 is illustrated in FIGS. 2A-2E. The device 110 may include a compact case 205 and a heat sink 228. The heat sink 228 may be located over or above the case 205. The case 205 includes a front panel 210a, a back panel 210b (collectively “panels 210”) and multiple panel mounts. The panel mounts include a pair of High-Definition Multimedia Interface (HDMI) panel mounts or ports 212a, 212b located on the front panel 210a and back panel 210b respectively. A HDMI IN port 212a may be located on the front panel 210a. A HDMI OUT port 212b may be located on the back panel. A HDMI video source (not shown), such as, a HDMI video camera, may be connected to the HDMI IN port 212a. A video stream may be displayed in full screen on the HDMI OUT port 212b. The HDMI ports 212a, 212b may be provided with a cover 212aa, 212bb to protect the ports from dust and damage.

The case 205 further includes a pair of standard hardware cable interfaces, such as, Universal Series Bus (USB) mounts or ports 214a, 214b located on the front panel 210a and back panel 210b respectively. The USB ports 214a, 214b may be provided with a cover 214aa, 214bb to protect the ports from dust and damage. The case 205 further includes an Ethernet port 216 for connecting the device 110 to a network. The Ethernet port 216 may also be provided with a dust cover 216a. The case 205 further includes a power panel mount 218 and a corresponding dust cover 218a. In one embodiment, an external 12V battery may be connected to power inlet 218.

A plurality of indicators 220a, 220b, 220c may be mounted on the front panel 210a. The indicators 220a, 220b, 220c may be LED or other suitable indicators that can provide a visual indication of an activity or state, such as, recording, status or power.

The front panel 210a may further include a pair of push buttons 222a, 222b. Button 222a may be a “record” button while button 222b may be a “power” button. The buttons 222a, 222b may be manually activated by a user/operator or they can be configured to be controlled and activated remotely. For example, if using a 315 mHZ wireless remote, a signal can be sent to the device 110 over the USB port 214a and processed by the device 110. If using a 2.4 gHz wireless remote keyboard key, a signal may be sent to the device 110 over the USB port 214b and processed by the device 110. The record button 222a acts as a toggle and it is associated with a glowing LED indicator 220a when the device 110 is recording.

The device 110 further includes a motherboard and an HDMI impedance board (not shown) and a mounting frame therefor. Screw mounts for the motherboard and the impedance board may be located on the floor of the case 230.

The case 205 may be manufactured from water resistant material. For example, the case 205 may be manufactured from water resistant aluminum. In one embodiment, the case 205 may be about 10-14 inches long, about 5-9 inches wide and about 1-5 inches in height. Preferably, the case 205 may be about 12 inches long, 7 inches wide and 3 inches in height. The heat sink 210 can spread heat generated by the motherboard to be cooled by air.

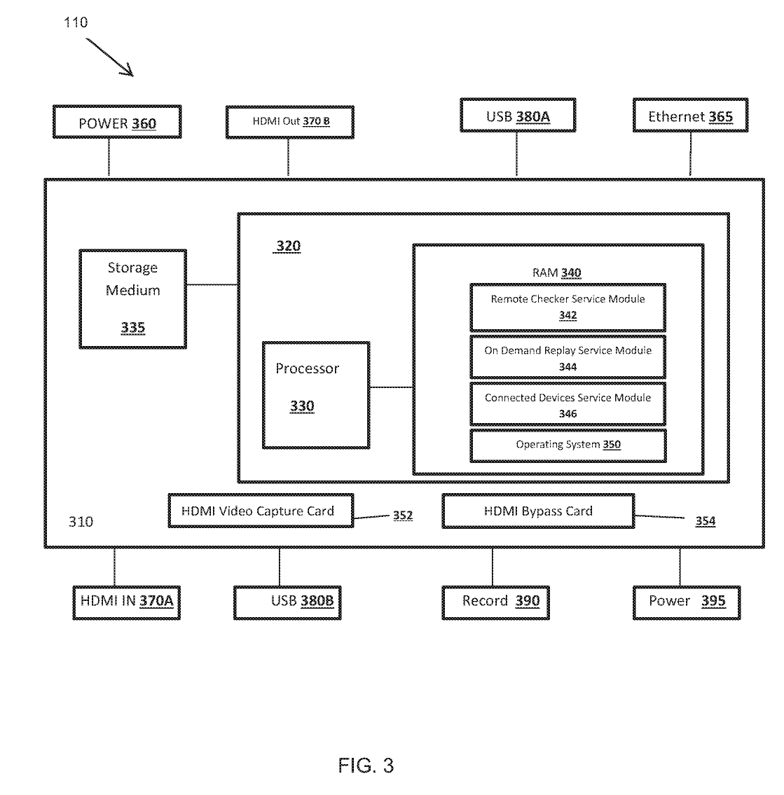

The device 110 includes a physical and tangible memory storage medium 335, as shown in FIG. 3, capable of having thereon on demand replay instructions that may be executed by a physical and tangible processor 330. The memory may take any form, such as, a memory stick. The device 110 further includes a suitable mass storage device (e.g., optical drives, solid state drives, and/or magnetic storage media drives. Any combination of one or more computer readable storage medium may be utilized. The computer readable storage medium may be a machine readable signal medium or a storage device, such as, but not limited to, an electronic, magnetic, optical, electromagnetic, infrared, holographic, micromechanical, or semiconductor system, apparatus, or device, or any suitable combination of the foregoing. In the context of this document, a computer readable storage medium may be any tangible medium that can contain, or store a software program for use by or in connection with an instruction execution system, apparatus, or device. The storage medium may be capable of storing several hours of high definition video clips. The device 110 can further include a computer bus interface to connector bus adaptors to the storage devices.

The device 110 includes a General Purpose Input/Output (GPIO) signal emitter and detector that may be built into the motherboard. The device 110 also includes a HDMI capture device, such as, a card, for converting input video signals into a video stream format accessible from an operating system 350 on the motherboard. The operating system may be LINUX, iOS, Mac OS, Darwin, RTXC, UNIX, OS X, WINDOWS, etc. Cable ports may be mounted on the panels 210a,b. They passively connect to the indicators 220a-220c. The push buttons 222a, 222b may be connected to general purpose input/output ports or to power inlet 218.

Device 110 is a stand-alone apparatus specifically configured for enabling and synchronizing on demand replays. Therefore, the device 110 can eliminate the need for a separate computer and game capture card to create video clips from a video camera into replays transmitted to portable computing devices 130a,b. The device 110 may be configured to recognize other similar devices connected to a common network and can receive video clips cooperatively to generate a merged video clip with views from multiple camera angles. The device 110 may also allow HDMI pass through. Thus, a connected camera (not shown) can display video out of the HDMI port while it is turned on.

The device 110 can be configured for recording and transfer/distribution of video files from HDMI-compliant source devices (such as, video cameras) to one or more portable computing devices. Alternately, the device 110 can also be configured for recording and transfer/distribution of video files from non-HDMI-compliant source devices, such as an older style RCA camera, via a software development conversion kit that can plug into it. The device 110 can be configured to allow multiple angle recording of an event and send them to a device that initiated the recording session (the primary device) or save the recorded clips (if it is the primary device). The primary device can be configured to optionally combine multiple angles into a single clip if the clips were recorded over an overlapping time period.

FIG. 3 is a block diagram illustrating an example of a device 110 for managing the merging of multi-angle video streams. The device 110 is configured to receive video signals from at least one connected video camera (not shown) via one or more communication networks, and transfer the videos to one or more portable computing devices (not shown). The communication network may include connections, such as wire, wireless communication links, and/or fiber optic cables. The communication network can be implemented as, or include, any of a variety of different communication technologies such as a wide area network (WAN) or a local area network (LAN). In this regard, the communication network can include one or more trunk lines, routers, switches, transceivers and/or the like.

The device 110 can include at least a processing system 320, which includes at least one processor 330 and memory 340, can be configured to receive video signals through a HDMI capture device 352 and to transmit videos and associated metadata information to portable computing devices for displaying the videos via the communication network. The HDMI capture device 352 may be a card for capturing HDMI video signals or 3G-SDI and HD-SDI video input (which are used in professional broadcasts). The device 110 may further include a HDMI bypass card 354. The HDMI bypass card 354 is configured to clean up any dirty HDMI signals from the video camera and to help prevent the HDMI capture device from getting a power surge. The device 110 further includes a power port 360, an Ethernet port 365, HDMI IN and HDMI OUT ports 370a and 370b, USB ports 380a and 380b, a record button 390 and a power button 395.

An on demand replay application configured to transfer video streams to the portable computing devices is stored in memory 340 and executable by the processor 330. The on demand replay application can include a remote checker service module 342 which communicates with a core on demand replay service module 344 which in turn communicates with a connected devices service module 346. Operating system 350 is stored in memory 340. The modules 342, 344, 346 may be implemented as one or more sub-modules operating in separate software layers or in the same layer. Although depicted as being separate from the operating system 350, the modules 342, 344, 346 or one or more sub-modules making up one or more of the modules 342, 344, 346 may be incorporated into the operating system 350.

The remote checker service module 342 manages the pressing of the buttons 390, 395 of the device 110. The remote checker service module 342 receives a signal from another one of the connected devices (not shown) that sends a start/stop recording toggle signal and sends that signal through to the on demand replay service module 344.

The on demand replay service module 344 detects the signal from the remote checker service module 342. It constantly broadcasts the names and recording status of the device 110 on the network over UDP (User Datagram Protocol). The on demand replay service module 344 also constantly listens for UDP broadcasts from all other connected devices. When the on demand replay service module 344 detects a signal from the remote checker service module 342, it checks the current recording status of all connected devices in the system. If the system is not recording, in response to the signal, the on demand replay service module 344 instructs the video cameras to commence live recording of a video stream. If the system is recording, in response to the signal, the on demand replay service module 344 stops the recording session from the connected video camera. The on demand replay service module 344 can save the recorded video stream for the particular recording session to the storage medium 335. The on demand replay service module 344 also saves metadata information for the recording session to the storage medium 335. If the on demand replay service module 344 determines that the start recording signal for the particular recording session was sent by another device (that is, another device is the primary device for the recording session), it can collect all the recording files and metadata for that particular recording session and send it to the primary device that initiated the recording. The on demand replay application then begins broadcasting its name and recording status to all devices on the network over UDP.

The on demand replay service module 344 communicates with the connected devices service module 346 to exchange information about any and all video streams collected from the connected devices. The connected services module 346 is the liaison between the device 110 and the portable computing devices. The portable computing device constantly pings or polls the core or primary on demand replay service module 344 to see if any new video streams or files are available to be downloaded. If a new file(s) is detected, an index containing all of the metadata is downloaded. The actual video files are then downloaded to the portable computing devices. The portable computing device can save the clips from multiple angles and make them available to a user as a single feed. The portable computing device can also display the clips based on the captured angles, for example, as angle 1, angle 2, etc. Alternately, the connected devices service module 346 can facilitate uploading video metadata and video files from the portable computing device to the device 110.

C. Method for Managing Distribution of a Multi-Angle Video Stream

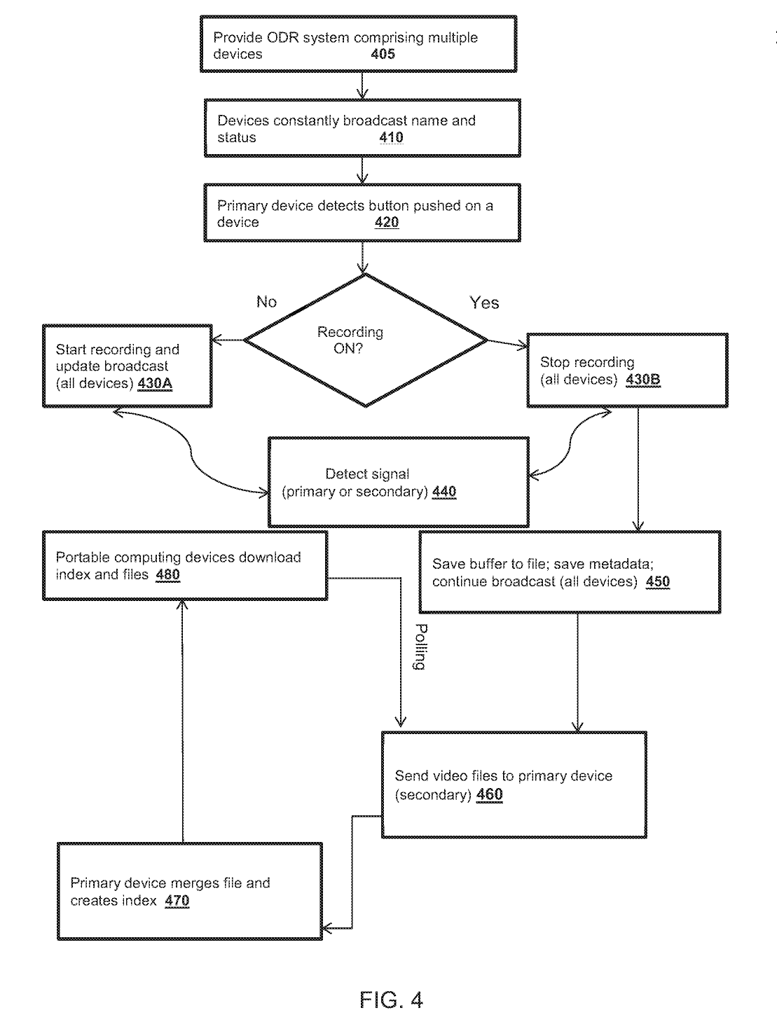

FIG. 4 illustrates a method for managing distribution of a multi-angle video stream. In Step 405, an ODR system described previously is provided. The ODR system may include a plurality of devices configured to coordinate the recording of a video stream using connected video cameras. The video cameras may be positioned such that a particular event may be recorded from multiple angles.

As shown in Step 410, each device constantly broadcasts its name and recording status of all other devices on the network. Each of the devices is also constantly monitoring and listening for broadcasts from other devices on the network. Each device can also constantly monitor the status of its own connected video cameras and any remote controllers.

When a device having a different recording status is detected, as shown in Step 420, a start/stop signal may be sent to each of the devices. The signal may be received via a connected video camera or via a remote controller or via an operator/user manually pushing the “Record” button on one of the devices. The device that first detects the signal becomes the primary device. The signal may be a “start recording” or a “stop recording” toggle signal. The primary device starts or stops recording and also sends a signal to all the other connected devices to commence or terminate a recording session. The other connected devices become secondary devices for the session—there could be one or more such secondary devices in communication with the primary device.

If the ODR system is not currently recording, in response to the detected signal, each of the devices starts recording a live video stream from their connected video camera. Each of the devices continues to broadcast its name and recording status to the other devices in the network, as shown in Step 430A. As illustrated in Step 440, the devices continue to record the live video stream until another signal is detected. The signal may be detected by either a primary or secondary devices.

If the ODR system is currently recording, in response to the detected signal received via the connected video cameras or via a remote controller or via an operator/user pushing the “Record” button on the front panel of any one of the connected devices (primary or secondary), each of the devices stops recording the live video stream from the connected video camera. This causes the recording session to be terminated. Even if the signal to stop recording is received from a secondary device, all the secondary devices and the primary device stop the recording session. The device that initiated the recording session continues to be primary device for the terminated recording session. Each of the devices continues to broadcast its name and recording status to the other devices in the network, as shown in Step 430B.

As shown in Step 450, the video stream may be saved to the hard drive/storage device of each of the devices. The secondary devices can continuously process and store the clips until they receive instructions to stop the recording. Each of the secondary devices compiles their corresponding video files for the recording session and transmits them to the primary device. Metadata on the video stream may also be saved to the hard drive.

The saved video streams and metadata information from the secondary devices is transferred to the primary device in Step 460. Typically, the second devices can continue to store their own clips locally while sending any new video clips to the primary device. Unlike the primary device, the secondary devices do not have an entire or merged suite of clips for a recording session. However, in an alternate embodiment, the secondary devices may also be provided with the entire suite of multi-angle replay video clips. This would allow the user the option to synchronize the entire suite of multi-angle replays.

As shown in Step 470, the primary device can format, edit, merge and save the video stream from the secondary devices with its video stream and create a metadata information index. The primary device processes its and the video streams received from the secondary devices for indexing and links them together via a metadata file. The video streams may also be synchronized and formatted. After the video streams have been synchronized and formatted, they can be made available to any connected portable computing device. There could be a plurality of such portable computing devices.

Portable computing devices, as shown in Step 480, may be continually polling the primary device for the saved metadata information index. When the portable computing devices detects a new file(s), the index containing all of the metadata is downloaded. The actual video files are now downloaded to the portable computing devices. If multiple video streams have been previously associated with one event, for example, by the primary device, then all associated video stream can also be downloaded by the portable computing device. The portable computing devices can save the multi-angle video streams and make them available to a user as a single feed. The portable computing devices can also display the video stream based on the captured angles, for example, as angle 1, angle 2, . . . as a multi-angle replay clip.

Optionally, in one or more embodiments, the portable computing devices may transfer the saved video streams and metadata information index to the primary device.

Although not shown in this flowchart, the capturing, processing and storing of video streams can be paused and resumed at any time. The pausing can be prompted using a stop capture indicator and the resuming can be prompted by a start capture indicator generated by, for example, a control server or by the primary device or the secondary devices.

D. Method for Capturing a Video Signal

FIG. 5 shows a method for capturing a video signal. The method includes the step of providing the device described with reference to FIGS. 2A-2E. The device may be connected to a source of HDMI videos, such as, as a HDMI video camera. This is shown in Step 510. The HDMI video camera may be connected to the HDMI IN port on the device. As shown in Step 520, a video signal received from the video camera may be transferred to the HDMI impedance board. This HDMI video signal may be balanced and transferred to the HDMI capture device. This is shown in Step 530. As shown in Step 540, the HDMI capture device converts the video signal into a video stream that can be accessed from the operating system of the device.

E. Operation of the ODR System at an Entertainment or Sporting Event

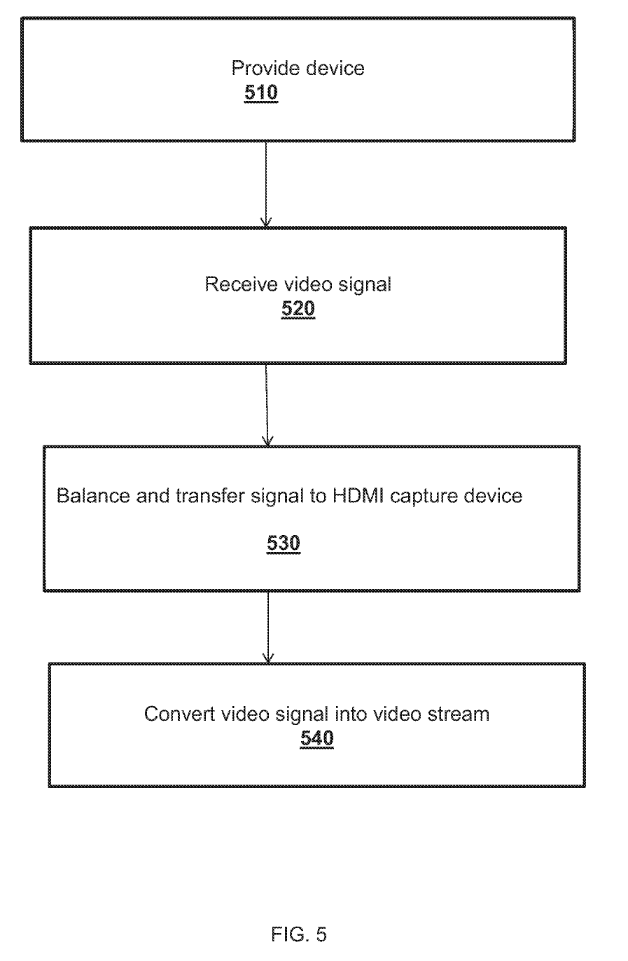

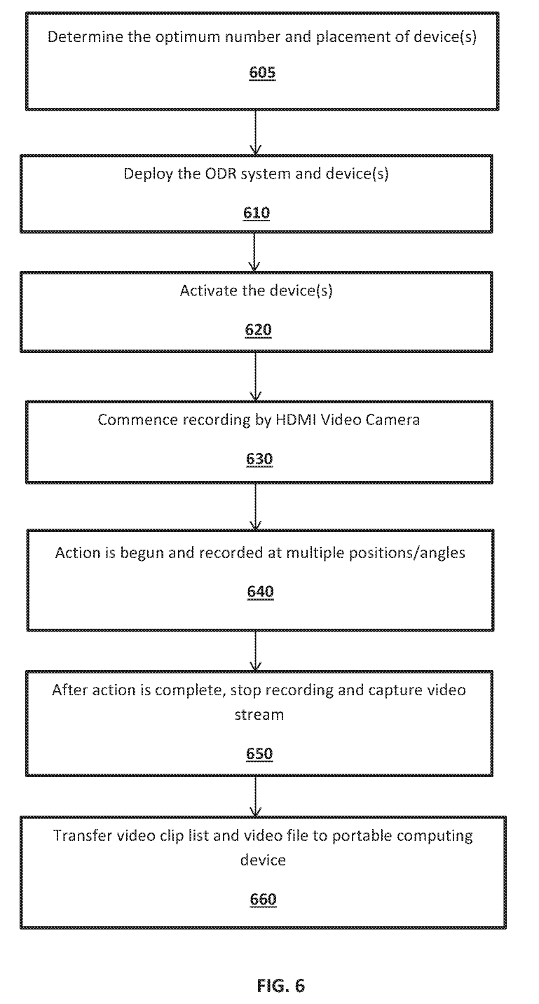

A method for employing the ODR System and managing video stream at an entertainment or sporting event is illustrated is FIG. 6. As shown in step 605, the operator of the system must analyze the performance or sport event and the staging area involved to determine the optimum number of devices (one or more) and the placement of those device(s) that will produce the best video files for review. Once the number of device(s) and their placement has been determined the operator will deploy the device(s) 110, as discussed with the reference to FIGS. 2A-2E, at the desired locations to provide views of the desired angles. This is shown in Step 610. For example, in a relay race one camera may be positioned to take a video stream at the finish line and one or more cameras may be positioned to record the passing of the baton.

As shown in Step 620, the device(s) are activated either manually or remotely. For example, an operator can remotely activate the device(s) by pressing a button on a remote controller or using a pressure sensor, motion detectors, target motion detectors, audio actuation, a timer, and/or a keyboard. The primary device 110a receives the signal to commence the recording session, as shown in Step 630, and then it searches for, recognizes, and synchronizes the recording from any secondary devices 110b-d.

Once the action is started the device(s) will activate their associated cameras 120 to record the activity at multiple positions and/or angles, as shown in Step 640. When the activity is completed, the primary device 110a receives a signal to stop recording, any secondary devices 110b-110d will cease recording as well, as shown in Step 650. This will trigger the secondary devices 110b-110d to send their clips of the same event to the primary device 110a. The primary device 110a processes the video stream (using the methods described earlier) and merges its clip with the clips received from secondary devices 110b-110d. The primary device 110a then transfers the video clip to a tablet or other portable computing device 130, shown in Step 660, where it is processed for instant replay. The portable computing device 130 may be connected through a network 140 (as described with reference to FIG. 1).

The embodiments of the invention may be used to film sporting events, practice, action events, and/or any other event in time that requires or can use instant playback ability for analysis. However, the ODR system can be utilized in many other applications such as: football, basketball, baseball, volleyball, softball, golf, wrestling, track and field, tennis, lacrosse, badminton, cheerleading, gymnastics, marching band, snowboarding, skiing, tubing, swimming and other water sports, race car vehicle recording, horse racing, dog racing, auto racing, aircraft racing, skateboarding, hoverboarding, inline skating, ice skating, long rifle shooting, archery, paintball, security systems, skydiving (landing), diving, parades, public speaking events, mechanical repairs, weightlifting, circus acts such as like lion taming and trapeze performances, sociology experiments, speech and language exercises, facial or body movement research, dancing, runway/catwalk events, art techniques, video game play, computer screen recording, award ceremonies, musical instrument playing, ballet, theatre, and other live events.

F. Methods for Managing Video Stream at a Rodeo Arena

Certain embodiments of the ODR system are designed for use at a rodeo arena or practice area for a number of events such as team roping, calf roping, barrel racing, steer wrestling, steer roping, bull riding, saddle bronc riding, bareback riding, team penning, cutting, working cowhorse, horse showing, reining, dressage, hunter/jumper, equestrian riding, steeplechase, western pleasure riding, mounted shooting, pole bending, goat tying, breakaway roping, English riding, and polo.

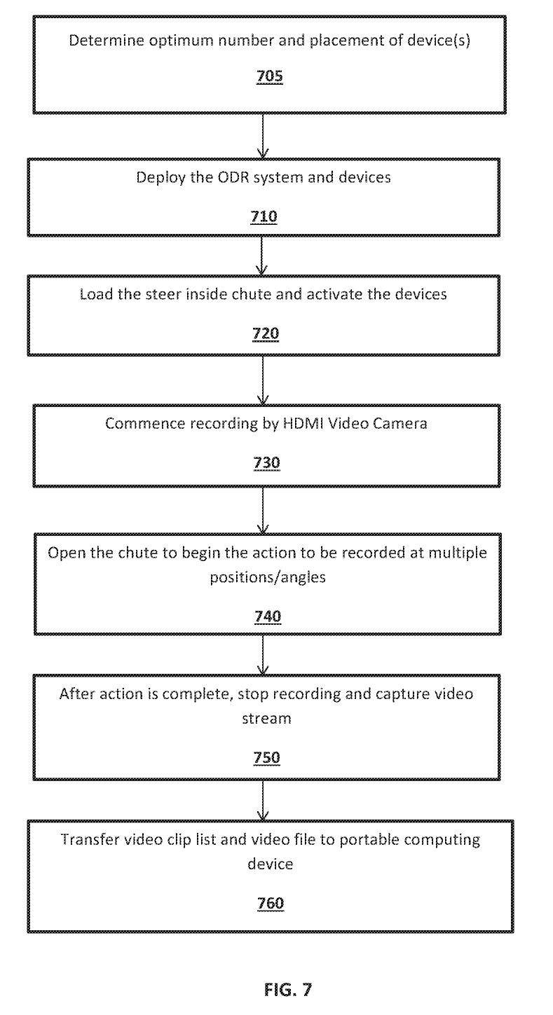

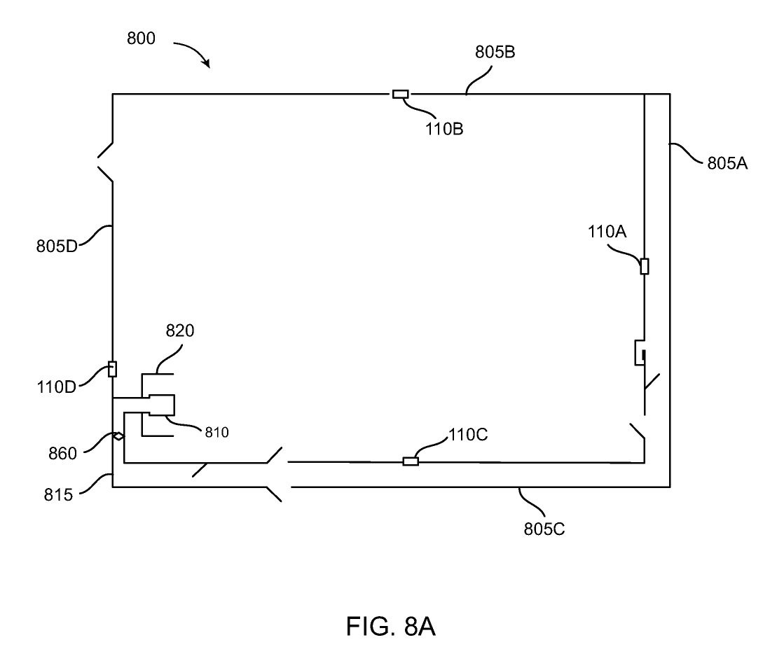

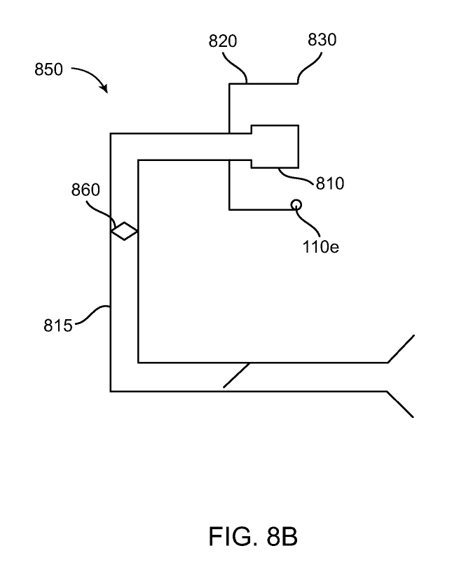

For example, a method for managing video stream at a rodeo arena, or practice area for team roping is illustrated in FIG. 7 and described below. The operator of the ODR system may be a rider or an associate. FIG. 8A is a block diagram of a rodeo arena 800 where team roping events are typically performed, the rodeo arena includes fences 805 A-D, an alleyway 815, a chute 810, and rider boxes 820. FIG. 8B is a block diagram of a practice area 850 having an alleyway 815, an alley stop 860, a chute 810 and rider boxes 820.

As shown in Step 705, the operator and/or the riders will determine the desired number and placement of the devices 110 in the rodeo arena or practice area 850. The typical actions of the riders, the horses and the steer during a team roping event are analyzed for the optimum placement of the devices 110. A brief description of team roping follows.

The steers used for roping are moved from a holding corral through a narrow alleyway 815 leading to the roping arena or practice area. Then, one at a time, a steer is loaded into a chute 810. A rider box 820 is located on each side of the chute with an area that is big enough to hold a horse and rider. The header, the rider that ropes the steer around the horns and turns the steer, starts from the rider box on one side of the chute and the healer, the rider that ropes the steer's hind legs, starts from the rider box on the other side of the chute. A taut rope, called the barrier, runs in front of the header's box and is fastened to an easily released rope on the neck of the steer of a sufficient length to ensure that the steer gets a head start. An electronic barrier, consisting of an electric eye connected to a timing device, is sometimes used in place of the barrier rope. Both riders must start from inside a rider box and if the header breaks the barrier, there is typically a 5 second penalty. When the header is ready, he or she calls for the steer and the chute doors are opened. The freed steer breaks out running. When the steer reaches the end of the rope, the barrier releases. The header ropes the steer and turns the horse and steer. Once the header has turned the steer, the healer throws a loop of rope under the running steer's hind legs and catches them. The header then turns his or her horse to directly face the steer and heeler. Both horses back up slightly to stretch out the steer's hind legs, immobilizing the animal. As soon as the steer is immobilized, an official waves a flag and the time is taken.

The optimum placement of the devices 110 is determined by the desired views of the arena or practice area as shown in Step 705. A first or primary device 110a can be placed anywhere in the arena 800 as long as it is substantially within the frequency range of a remote controller. Typically when recording an event in a rodeo arena, the first device 110a is placed within 250 feet of the a remote controller and is often placed at the back of the arena 805A in order to capture a wide angle shot of the entire run or event. Additional devices 110b, 110c, 110d may be optionally placed near the front 805D or on the sides 805B, 805C of the arena for more detailed images or for obtaining multiple angle views of the same event or run. In addition, a device may be mounted on top of the chute or at the front of one of the rider boxes if the rider desires to capture a view of the barrier. In certain embodiments, particularly of the practice area 850 this device 110e may be designated as the primary device. The penalties given if the header breaks the barrier can easily cost team ropers a win or place in team roping competitions. Therefore training a horse and rider to wait for the removal of the barrier, but not to waste any time after the barrier removal, is an important aspect of winning at team roping.

Once the desired number and placement of the devices has been determined, the operator will deploy the ODR system and the devices at the arena or practice area. This is shown in Step 710. Each of the devices 110a-110e may be connected to a HDMI video camera (not shown) and each of the devices 110a-110e may also be connected to each other.

When the ODR system and the devices are in place, a steer is loaded inside a chute 810. A preferred embodiment of the chute 810 is the remotely operable gated chute disclosed in U.S. Pat. No. 7,918,191, the content of which is incorporated by reference in its entirety herein. The devices are activated either manually or remotely at this time as shown in Step 720. For rodeo events, the recording session is usually initiated on the designated primary device 110 by actuating it remotely. In the rodeo arena, the first device 110a typically becomes the primary device while the optional devices 110b-110e are the secondary devices for the recording session. The first device 110a, however, can be actuated by other mechanisms as well. Examples of other actuating mechanisms include a pressure sensor embedded in the rider's clothing or mounted on a saddle, motion detectors, audio actuation, a timer, or a keyboard. Remote activation of the primary device may involve a remote controller or a remote interface such as a button, a knob, a lever, a switch, or a dial to activate the primary device 110a. Since the devices are connected to HDMI cameras, once the devices are activated the cameras will start recording a live video stream of the session. This is shown in Step 730.

Although the operator may be a rider or an associate. The remote activation of the devices and cameras is especially valuable to equine/horse related events and sports when the operator is a rider. For instance, in team roping events, there are two riders and both riders must remain on horseback in order to complete a run. Currently available filming systems disadvantageously require a third person to operate a video camera to film a team roping practice session if the two riders remain mounted. In contrast, the use of the ODR system with a remote controller to actuate the primary device easily allows the video camera to be operated by a rider. This is particularly important for safety reasons. When a rider is on horseback, he or she must be mindful of his/her environment at all times. Operating a camera by hand, while on horseback can be difficult and can agitate the horse, putting the rider at risk. The described embodiments of the invention substantially eliminate all of the risk of rider injury and save time during practice sessions.

Once the primary device has been activated, the gate of the chute is opened either manually or remotely. The primary device and the chute may be actuated together or separately. If a remotely operable gated chute is used such as the chute disclosed in U.S. Pat. No. 7,918,191, the rider can activate the devices and open the chute by pressing a first button on a remote controller. Alternatively, when the rider calls for his or her steer, the rider can press a separate second button on the same remote controller to actuate the chute and open the front gates of the chute. In other embodiments, the remote controller for actuating the chute may be separate from the remote controller for actuating the device. The remote controller may (not shown) be an electronic handheld control unit that has a radio transmitter. Preferably the transmitter will have a range in excess of 165 feet (50 meters). Whenever a signal from the remote controller is detected, electrical power to a non-latching solenoid on the front gates is activated for a short period thereby opening the front gates of the chute. Once the chute is opened the steer begins running and the activity is recorded at multiple positions and angles, as shown in Step 740.

After the run is complete, the rider can press a second or third button on the remote controller to stop the recording. As soon as the connected video camera receives the signal to stop recording, it transfers the video stream to the device through the HDMI IN port on the device. This is shown in Step 750. The video stream is processed by the device (using the methods described earlier). As shown in Step 760, the video clip may be transferred by the device to a connected tablet or other portable computing device. The portable computing device may be connected to the device through a WAN network (as described with reference to FIG. 1). The embodiments of the invention facilitate the recording and storage of video clips of multiple practice runs. Since the primary device 110a can cut a clip and transfer it to a portable computing device instantly. The video clip can be instantly viewed on a portable computing device, such as a smartphone, by the rider.

Each of the devices 110a-110e may also have an outlet for a direct to monitor option where it can be viewed on a bigger screen than a tablet or other portable computing device. It can have playback capabilities on mobile devices, televisions, gaming consoles, computers, projectors, digital scoreboards/jumbotrons, watches, virtual reality headsets, and augmented reality headsets. After the clip is transferred, it can be viewed in slow motion, zoomed in and out, paused and played back frame by frame, and can enter a “draw mode” where further analysis can be made. The clips can be sorted by name or by different category labels such as “favorites.”

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

As will be appreciated by one skilled in the art, aspects of the embodiments may be embodied as a system, devices, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code. The storage devices may be tangible, non-transitory, and/or non-transmission.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of the device to produce a machine, such that the instructions, which execute via the processor of the device, create means for implementing the functions/acts specified in the flowchart and/or block diagram block or blocks. These computer readable program instructions may also be stored in a computer readable storage medium that can direct device to function in a particular manner, such that the computer readable storage medium having instructions stored therein comprises an article of manufacture including instructions which implement aspects of the function/act specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by the device that performs the specified functions or acts.

We claim:

1. An on-demand replay system comprising:
(A) a plurality of video cameras for recording one or more video clips of an event from multiple angles;
(B) a plurality of devices in cooperative communication, wherein at least one video camera is connected to each device, and wherein each device is configured to constantly monitor and recognize each of the other devices; and
(C) one or more portable computing devices for receiving the multiple angle video clips.

2. The system according to claim 1, wherein each device comprises:
a compact case, wherein the case comprises a front panel;
a heat sink located above the case;
a recording button mounted on the front panel of the case; and
a High-Definition Multimedia Interface (HDMI) input port mounted on the front panel of the case, wherein the video camera is connected to the device through the HDMI input.

3. The system according to claim 1, wherein the device further comprises a HDMI capture card for capturing the one or more recorded video clips from the connected video camera.

4. The system according to claim 1, wherein the device further comprises:
one or more computer readable storage media;
program instructions stored on at least one of the one or more computer readable storage media for execution by at least one of the one or more computer processors, the program instructions comprising:
program instructions to receive a signal from the other devices to commence or to terminate the recording of the video clip.

5. The system according to claim 4, wherein the device further comprises program instructions to broadcast its name and recording status to the other devices.

6. The system according to claim 5, wherein each device further comprises program instructions to check a current recording status of the other devices.

7. The system according to claim 1, wherein the portable computing device further comprises program instructions for constantly polling the plurality of devices to determine if a new a video clip has been added.

8. The system according to claim 1, wherein a first and a second video camera is positioned such that the first video camera records a first video clip of the event from a first angle and the second video camera records a second video clip of the event from a second angle.

9. The system according to claim 8, wherein each portable computing device is configured to allow a user to view the first video clip from the first angle, the second video clip from the second angle and a merged first and second video clip from the first and second angles.

10. The system according to claim 1, the video clip comprises a sporting or entertainment event or a sporting practice session.

11. A method for managing multiple angle video clips comprising:
providing a plurality of video cameras for recording one or more video clips of an event from multiple angles;
providing a plurality of devices in cooperative communication, wherein each device is connected to at least one of the video cameras, and wherein each device constantly checks the recording status of all the other devices; and
designating a first device as a primary device upon the condition that the first device detects a signal to start or stop the recording before all the other devices.

12. The method according to claim 11, further comprising enabling each of the devices to broadcast its name and recording status to all the other devices.

13. The method according to claim 11, wherein, upon detecting the signal, the primary device instructs all the other devices to commence recording if it determines that none of the other devices are recording the event.

14. The method according to claim 11, wherein, upon detecting the signal, the primary device instructs all the other devices to stop recording if it determines that one or more of the other devices are recording the event.

15. The method according to claim 14, wherein, upon stopping the recording, enabling each of the devices to access and store the recorded video clips.

16. The method according to claim 15, further comprising transferring the recorded video clips to the primary device, wherein the primary device is configured to format, edit and merge the video clips.

17. The method according to claim 16, further comprising transferring the merged video clips to a portable computing device.

18. The method of claim 12 further comprising:
analyzing an entertainment or sporting event and a staging area for the event to determine a desired number and location of devices and cameras;
deploying the desired number of cameras at the desired camera locations at the staging area;
deploying the desired number of devices at the desired locations at the staging area, wherein the primary device comprises a remotely actuatable recording button;
providing an actuating signal to remotely actuate the recording button of the primary device, wherein the actuation of the recording button of the primary device commences a video recording session and wherein the primary device instructs all other devices to commence recording;
providing a signal to remotely stop the video recording session of the primary device when the entertainment or sporting event is concluded, wherein the primary device instructs all the other devices to stop recording and enabling each of the other devices to access and store the recorded video clips and then to transfer the stored video clips of all of the other devices to the primary device, wherein the primary device is configured to format, edit and merge all of the video clips;
transferring the merged video clips from the primary device to a portable computing device.

19. A method for remotely recording a video in a rodeo arena, the method comprising:
deploying a predetermined number of devices at predetermined sites in the arena, wherein all of the devices are in cooperative communication and each device is connected to at least one video camera for recording one or more video clips;
designating a first device as a primary device, wherein the primary device detects a signal to start or stop recording before all of the other devices and subsequently instructs all of the other devices to start or stop recording;
loading a steer inside a chute;
providing a signal to remotely actuate a recording button on the primary device, wherein the actuation of the recording button commences a video recording session;
remotely opening a front gate of the chute to coincide with commencement of a practice run; and
providing a signal to remotely stop the video recording session when the practice run is concluded;
enabling each of the devices to access and store the recorded video clips;
transferring the stored video clips of all of the other devices to the primary device, wherein the primary device is configured to format, edit and merge all of the video clips;
transferring the merged video clips from the primary device to a portable computing device.

20. The method according to claim 19, wherein the primary device is deployed at a back of the arena.

21. The method according to claim 19, wherein one or more of the primary device, the chute and/or the video camera are actuated by a user operation on a remote controller.

22. The method according to claim 19, wherein the signal to remotely actuate the primary device is provided by an electronic handheld control unit that has a radio transmitter.

23. The method according to claim 19, wherein one device is deployed to capture a view of the barrier.
